(19) United States
(12) Patent Application Publication
(10) Pub. No.: US 2025/0265601 A1
(43) Pub. Date: Aug. 21, 2025

(54) INFORMATION PROCESSING DEVICE

(71) Applicant: TOYOTA JIDOSHA KABUSHIKI KAISHA, Toyota-shi (JP)

(72) Inventors: Tatcha TOCHAROEN, Nagoya-shi (JP); Liang GONG, Tokyo (JP)

(73) Assignee: TOYOTA JIDOSHA KABUSHIKI KAISHA, Toyota-shi (JP)

(21) Appl. No.: 18/970,924

(22) Filed: Dec. 6, 2024

(30) Foreign Application Priority Data
Feb. 19, 2024 (JP) 2024-023191

(51) Int. Cl. G06Q 30/018

(52) U.S. Cl. CPC G06Q 30/018

(57) ABSTRACT

An information processing device includes a control unit. The control unit acquires data of the carbon emission amount of the vehicle and a plurality of parameters correlated with the respective weights of the plurality of cargo groups transported by the vehicle. The plurality of cargo groups includes at least one luggage. The control unit calculates the carbon discharge amount for each of the plurality of cargo groups based on the data of the carbon discharge amount of the vehicle and the plurality of parameters.

### CROSS-REFERENCE TO RELATED APPLICATION

This application claims priority to Japanese Patent Application No. 2024-023191 filed on Feb. 19, 2024, incorporated herein by reference in its entirety.

### BACKGROUND

### 1. Technical Field

The present disclosure relates to an information processing device.

### 2. Description of Related Art

Distributors are occasionally requested to report a carbon emission amount of vehicles. For example, designated shippers with a cargo transport volume of 30 million ton-kilometers or more are obligated to periodically report a carbon emission amount to the Environment Agency. Thus, there is known a commercial transaction business system in which exhaust gas emitted from an engine of an automobile is associated with an owner and a user of the automobile (Japanese Unexamined Patent Application Publication No. 2004-252617 (JP 2004-252617 A)).

### SUMMARY

One logistics company occasionally receives a request to transport cargos from a plurality of shippers. In this case, it is useful if it is possible to grasp, for each shipper, how much the transportation of the cargos of the shipper contributes to the carbon emission amount.

According to the present disclosure made in view of such an issue, it is possible to grasp, for each shipper, how much the transportation of the cargos of the shipper contributes to the carbon emission amount.

An aspect of the present disclosure provides an information processing device including a control unit that acquires data on a carbon emission amount of a vehicle and a plurality of parameters correlated with respective weights of a plurality of cargo groups transported by the vehicle, the cargo groups including at least one cargo, in which the control unit calculates a carbon emission amount for each of the cargo groups based on the data on the carbon emission amount of the vehicle and the parameters.

According to the aspect of the present disclosure, it is possible to grasp, for each shipper, how much the transportation of the cargos of the shipper contributes to the carbon emission amount.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a block diagram illustrating a schematic configuration of a system according to an embodiment of the present disclosure;

FIG. 2 is a flowchart illustrating an example of operation of the system illustrated in FIG. 1;

FIG. 3 is a diagram illustrating an exemplary route from a departure point to a destination; and

FIG. 4 is a diagram illustrating another example of a route from a departure point to a destination.

### DETAILED DESCRIPTION OF EMBODIMENTS

Hereinafter, an embodiment of the present disclosure will be described below with reference to the drawings.

### Sample System Configuration

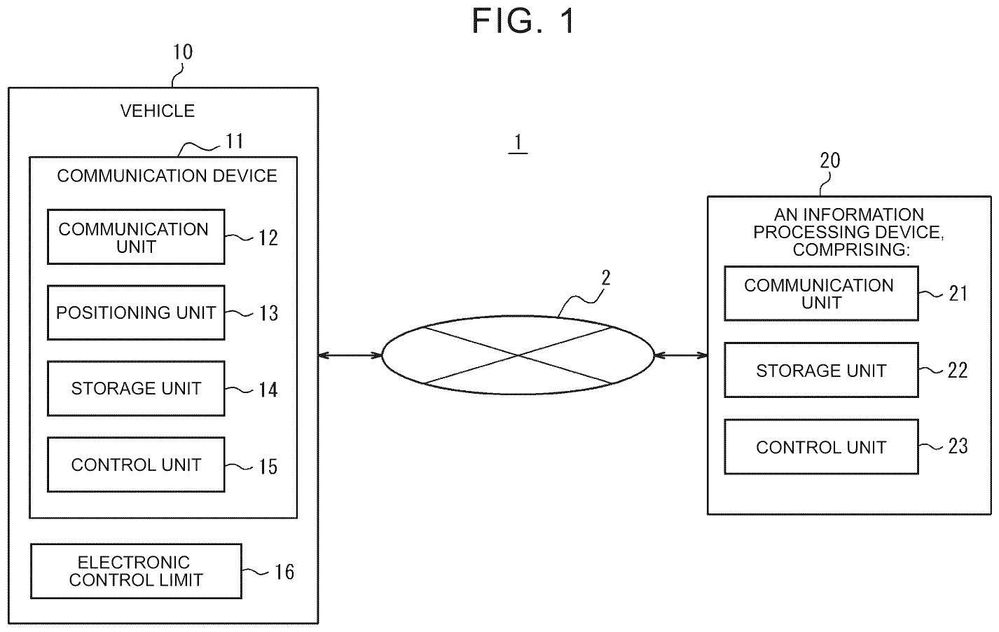

As illustrated in FIG. 1, the system 1 according to the present embodiment includes a vehicle 10 and an information processing device 20. In FIG. 1, the number of vehicles 10 included in the system 1 is one. However, the system 1 may include a plurality of vehicles 10.

The vehicle 10 and the information processing device 20 can communicate with each other via the network 2. The network 2 may be any network including a mobile communication network, the Internet, and the like.

The vehicle 10 is used, for example, by a logistics company. The vehicle 10 is, for example, a truck. However, the vehicle 10 may be any type of vehicle as long as it can transport a package.

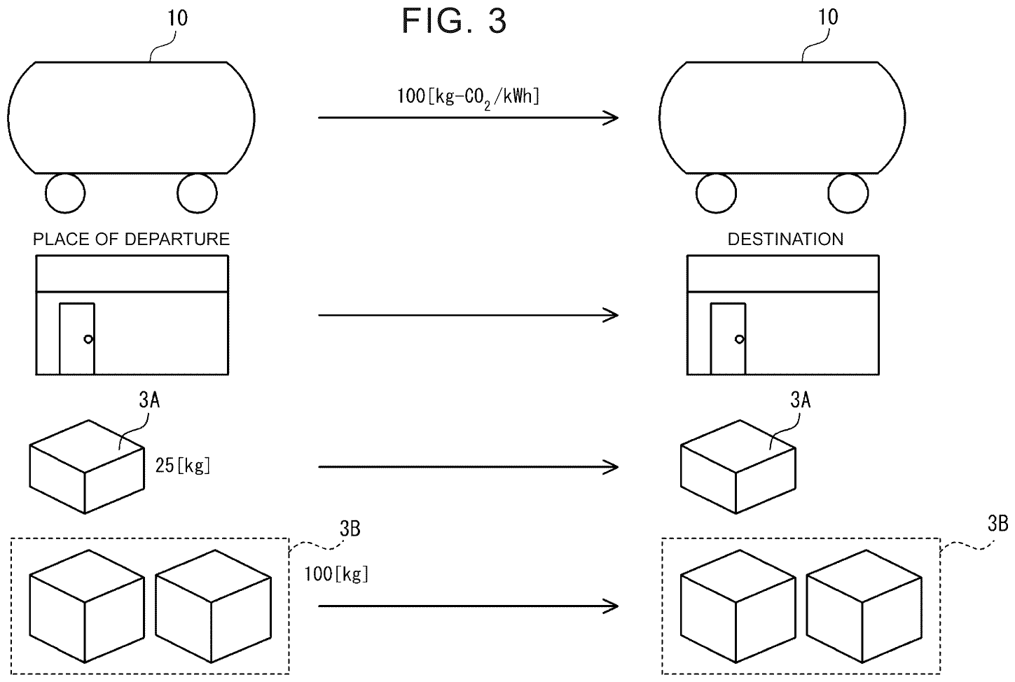

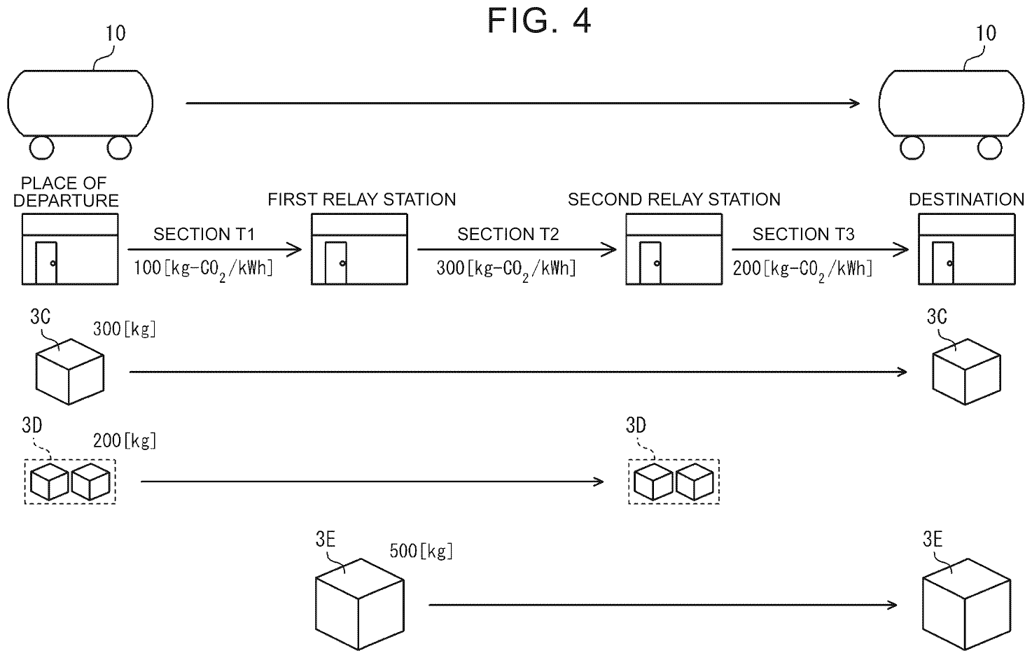

As illustrated in FIG. 3 or FIG. 4, which will be described later, the vehicle transports a plurality of packages from a departure point to a destination. The cargo group includes at least one luggage. The cargo group is set for each shipper. In other words, the cargo group may collectively include packages for each shipper. The consignor is also a requester who requests the logistics company using the vehicle 10 to transport his or her luggage. The route from the departure point to the destination may include one or more relays, as shown in FIG. 4 below. In response to a request from the shipper, the vehicle 10 may transport the cargo group from the departure point to the relay point or the destination, or may transport the cargo group from the relay point to another relay point or the destination.

The vehicle 10 includes a communication device 11 and an electronic control unit 16. The communication device 11 and the electronic control unit 16 can communicate with each other via an in-vehicle network such as a CAN (Controller Area Network) or a dedicated line. The communication device 11 includes a communication unit 12, a positioning unit 13, a storage unit 14, and a control unit 15. However, the communication device 11 may not include the positioning unit 13.

The communication unit 12 includes at least one communication module connectable to the network 2. The communication module is, for example, a communication module conforming to mobile communication standards such as the long term evolution (LTE), fourth generation (4G), or fifth generation (5G).

The communication unit 12 is configured to include at least one communication module capable of communicating with components of the vehicle 10, such as the electronic control unit 16. The communication module is a communication module corresponding to a standard of an in-vehicle network such as a CAN or a dedicated line.

The positioning unit 13 can acquire position information of the vehicle 10. The positioning unit 13 is configured to include at least one reception module corresponding to the satellite positioning system. The receiving module is, for example, a receiving module corresponding to the global positioning system (GPS).

The storage unit 14 includes at least one semiconductor memory, at least one magnetic memory, at least one optical memory, or a combination of at least two types thereof. The semiconductor memory is, for example, a random access memory (RAM), a read-only memory (ROM), or the like. The RAM is, for example, a static random access memory (SRAM), a dynamic random access memory (DRAM), or the like. ROM is, for example, EEPROM (Electrically Erasable Programmable Read-Only Memory). The storage unit 14 may serve as a main storage device, an auxiliary storage device, or a cache storage device. The storage unit 14 stores data used for the operation of the communication device 11 and data obtained by the operation of the communication device 11. The storage unit 14 may store an arbitrary program used for the operation of the communication device 11. For example, the storage unit 14 stores at least one of a system program, an application program, and embedded software.

The control unit 15 includes at least one processor, at least one dedicated circuit, or a combination thereof. The processor is, for example, a general-purpose processor such as a central processing unit (CPU) or a graphics processing unit (GPU), or a dedicated processor specialized for a specific process. The dedicated circuit is, for example, a field-programmable gate array (FPGA) or an application-specific integrated circuit (ASIC). The control unit 15 executes processing related to the operation of the communication device 11 while controlling each unit of the communication device 11.

The electronic control unit 16 is an ECU (Electronic Control Unit) of the vehicle 10. The electronic control unit 16 controls various functions of the vehicle 10.

The information processing device 20 is a dedicated computer configured to function as a server, a general-purpose personal computer, a cloud computing system, or the like.

The information processing device 20 is managed by, for example, a logistics company using the vehicle 10. As will be described later, the information processing device 20 calculates the carbon emission amount for each of the plurality of cargo groups transported by the vehicle 10. In the present embodiment, the carbon discharge amount of the cargo group is, for example, a carbon discharge amount which is considered to have contributed to the transportation of the cargo group among the carbon discharge amounts discharged by the vehicle 10 when the vehicle 10 transports the plurality of cargo groups.

The information processing device 20 includes a communication unit 21, a storage unit 22, and a control unit 23.

The communication unit 21 is configured to include at least one communication module that can be connected to the network 2. The communication module is, for example, a communication module compatible with a standard such as a wired local area network (LAN) or a wireless LAN. The communication unit 21 is connected to the network 2 via a wired LAN or a wireless LAN by a communication module.

The storage unit 22 includes at least one semiconductor memory, at least one magnetic memory, at least one optical memory, or a combination of at least two types thereof. The semiconductor memory is, for example, a RAM, or a ROM. The RAM is, for example, an SRAM or a DRAM. The ROM is, for example, an EEPROM. The storage unit 22 may function as a main storage device, an auxiliary storage device, or a cache memory. The storage unit 22 stores data used for the operations of the information processing device 20 and data obtained through the operations of the information processing device 20. The storage unit 22 may store an arbitrary program used for the operation of the information processing device 20. For example, the storage unit 22 stores at least one of a system program, an application program, and embedded software.

The storage unit 22 stores, for example, a plurality of parameters. The plurality of parameters is a parameter correlated to the weight of each of the plurality of cargo groups transported by the vehicle 10.

As an example, the plurality of parameters may indicate a weight of each of the plurality of cargo groups. The weight of the cargo group may be the sum of the weights of the packages included in the cargo group.

As another example, the plurality of parameters may indicate a volume of each of the plurality of cargo groups. The volume of the cargo group may be the sum of the volumes of the packages included in the cargo group. Here, the larger the volume of the load, the larger the weight of the load may be. Therefore, it can be said that the volume of the cargo group correlates with the weight of the cargo group.

As yet another example, the plurality of parameters may indicate a density of each of the plurality of baggage groups. The density of the cargo group may be an average value of the densities of the packages included in the cargo group, or may be the sum of the densities of the packages included in the cargo group. Here, the larger the density of the load, the larger the weight of the load may be. Therefore, it can be said that the density of the cargo group correlates with the weight of the cargo group.

The control unit 23 includes at least one processor, at least one dedicated circuit, or a combination thereof. The processor is a general-purpose processor such as a CPU or a GPU, or a dedicated processor specialized for a specific process, for example. The dedicated circuit is, for example, an FPGA or an ASIC. The control unit 23 executes processing related to the operation of the information processing device 20 while controlling each unit of the information processing device 20.

### Example of System Operation

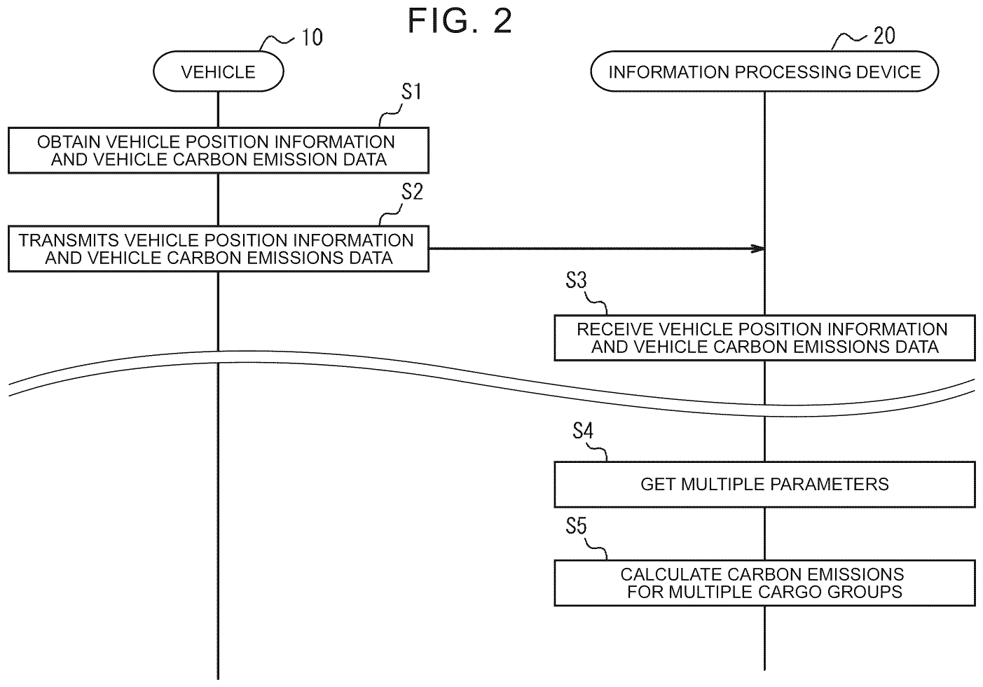

FIG. 2 is a flowchart illustrating an operation example of the system 1 illustrated in FIG. 1. For example, when the vehicle 10 starts from a departure point, the system 1 starts S1 process.

In S1 process, the control unit 15 of the communication device 11 of the vehicle 10 acquires the position information of the vehicle 10 and the carbon emission amount data.

As a process of acquiring the position information of the vehicle 10, the control unit 15 acquires the position information of the vehicle 10 by the positioning unit 13. However, for example, when the communication device 11 does not include the positioning unit 13, the control unit 15 may acquire the position information of the vehicle 10 by receiving the position information from the electronic control unit 16 by the communication unit 12.

As a process of acquiring data of the carbon emission amount of the vehicle 10, the control unit 15 may acquire the carbon emission amount by calculating the carbon emission amount of the vehicle 10. The control unit 15 may calculate the carbon emission amount of the vehicle 10 by, for example, a fuel method, a fuel consumption method, or an improved ton-kilometer method. The control unit 15 may receive any data used to calculate the carbon emission amount from the electronic control unit 16 by the communication unit 12. For example, in the fuel method, the carbon emission amount of the vehicle 10 is calculated using the data of the fuel consumption amount of the vehicle 10. Therefore, when the carbon emission amount is calculated by the fuel method, the control unit 15 receives the data of the fuel consumption amount of the vehicle 10 from the electronic control unit 16 by the communication unit 12. Further, in the fuel efficiency method, the carbon emission amount of the vehicle 10 is calculated by using the traveling distance data of the vehicle 10. Therefore, in the case of calculating the carbon emission amount by the fuel efficiency method, the control unit 15 receives data of the travel distance of the vehicle 10 from the electronic control unit 16 by the communication unit 12.

In S2 process, the control unit 15 transmits the position information of the vehicle 10 and the carbon emission amount data of the vehicle 10 acquired in S1 process to the information processing device 20 via the network 2 by the communication unit 12.

In S3 process, the control unit 23 of the information processing device 20 receives the position information of the vehicle 10 and the carbon emission amount data of the vehicle 10 from the vehicle 10 via the network 2 by the communication unit 21. In the present embodiment, the control unit 23 acquires the position information of the vehicle 10 and the data of the carbon emission amount of the vehicle 10 by receiving the position information of the vehicle 10 and the data of the carbon emission amount of the vehicle 10 from the vehicle 10. However, the control unit 23 may acquire the position information of the vehicle 10 and the data of the carbon emission amount of the vehicle 10 by an arbitrary method. For example, the control unit 23 may acquire the data of the carbon emission amount of the vehicle 10 by calculating the data of the carbon emission amount of the vehicle 10 in the same manner as or similar to the control unit 15 as described above in S1 process. The control unit 23 causes the storage unit 22 to store the received positional information of the vehicle 10 and data of the carbon emission amount.

Here, the communication device 11 repeatedly executes S1, S2 process at predetermined intervals until the vehicles 10 arrive at the destination. The predetermined time may be set based on the average speed of the vehicle 10 or the like. When the communication device 11 repeatedly executes S1, S2 process, in the information processing device 20, the control unit 23 repeatedly executes S3 process and repeatedly receives the position information of the vehicle 10 and the carbon emission amount of the vehicle 10.

S4 process is executed after the vehicles 10 arrive at the destination. For example, the control unit 23 of the information processing device 20 detects that the vehicle 10 has arrived at the destination from the position information of the vehicle 10 received in S3 process.

In S4 process, the control unit 23 acquires a plurality of parameters from the storage unit 22.

In S5 process, the control unit 23 calculates the carbon discharge amount for each of the plurality of cargo groups on the basis of the carbon discharge amount data acquired in S3 process and the plurality of parameters acquired in S4 process. An example of S5 process will be described below.

### Example 1

When the plurality of parameters indicate the respective weights of the plurality of cargo groups, the control unit 23 may calculate the weight ratios of the plurality of cargo groups by the plurality of parameters. The control unit 23 may calculate the carbon discharge amount for each of the plurality of cargo groups based on the data of the carbon discharge amount of the vehicle 10 and the weight ratio of the plurality of cargo groups. By using the weight ratios of the plurality of cargo groups as described above, it is possible to accurately calculate the carbon discharge amount for each of the plurality of cargo groups.

For example, as illustrated in FIG. 3, it is assumed that the vehicle 10 transports the cargo group 3A, 3B from the departure point to the destination. Further, it is assumed that the carbon emission from the departure point to the destination is 100 [kg-CO₂/kWh], the weight of the cargo group 3A is 25 [kg], and the weight of the cargo group 3B is 100 [kg]. Here, the control unit 23 calculates that the weight ratio of the cargo group 3A, 3B is (the cargo group 3A: the cargo group 3B=1:4). Further, the control unit 23 calculates that the carbon discharge amount of the cargo group 3A is 20 [kg-CO₂/kWh], and calculates that the carbon discharge amount of the cargo group 3B is 80 [kg-CO₂/kWh].

### Example 2

When the plurality of parameters indicates the respective volumes of the

plurality of cargo groups, the control unit 23 may calculate the volume ratios of the plurality of cargo groups by the plurality of parameters. The control unit 23 may calculate the carbon discharge amount for each of the plurality of cargo groups based on the data of the carbon discharge amount of the vehicle 10 and the volume ratio of the plurality of cargo groups. By using the volume ratios of the plurality of cargo groups as described above, it is possible to calculate the carbon discharge amount for each of the plurality of cargo groups even when the weights of the plurality of cargo groups are not known, for example.

### Example 3

When the plurality of parameters indicates the density of each of the plurality of cargo groups, the control unit 23 may calculate the density ratio of the plurality of cargo groups by the plurality of parameters. The control unit 23 may calculate the carbon discharge amount for each of the plurality of cargo groups based on the data of the carbon discharge amount of the vehicle 10 and the density ratio of the plurality of cargo groups.

### Example 4

The route from the departure point to the destination of the vehicle 10 may include a section in which at least some of the plurality of packages of the plurality of packages transported by the vehicle 10 are transported. For example, in FIG. 4, the vehicle 10 transports the cargo group 3C, 3D, 3E as a plurality of cargo groups. The route from the departure point to the destination of the vehicle 10 includes the section T1, T2, T3. The section T1 is a section from the departure point to the first relay point. The section T2 is a section from the first relay point to the second relay point. The section T3 is a section from the second relay point to the destination. The vehicle 10 transports the cargo group 3C, 3D in the section T1 among the cargo group 3C, 3D, 3E. The vehicle 10 transports the cargo group 3C, 3D, 3E in the section T2 among the cargo group 3C, 3D, 3E. The vehicle 10 transports the cargo group 3C, 3E in the section T3 among the cargo group 3C, 3D, 3E.

When the route from the departure point to the destination of the vehicle 10 includes the above-described section, the control unit 23 acquires data of the carbon emission amount of the vehicle 10 in the section on the basis of the position information of the vehicle 10 and the data of the carbon emission amount acquired in S3 process. Further, the control unit 23 calculates the carbon discharge amount for each of the plurality of cargo groups transported in the section based on the data of the carbon discharge amount of the vehicle 10 in the section and the plurality of parameters correlated with the respective weights of the plurality of cargo groups transported in the section.

For example, in FIG. 4, the control unit 23 acquires 100 [kg-CO₂/kWh] of the carbon emissions of the section T1. The control unit 23 acquires 300 [kg-CO₂/kWh] of the carbon emissions of the section T2. The control unit 23 acquires 200 [kg-CO₂/kWh] of the carbon emissions of the section T3. Further, in FIG. 4, the parameter correlated with the weight of the cargo group 3C indicates 300 [kg] which is the weight of the cargo group 3C. The parameter correlated to the weight of the cargo group 3D indicates 200 [kg] which is the weight of the cargo group 3D. The parameter correlated to the weight of the cargo group 3E indicates 500 [kg] which is the weight of the cargo group 3E.

For example, in the section T1 in FIG. 4, the control unit 23 calculates that the weight ratio of the cargo group 3C, 3D is (the cargo group 3C: the cargo group 3D=3:2) based on the parameter of the cargo group 3C, 3D. The control unit 23 calculates, based on T1 of 100 [kg-CO₂/kWh] of the carbon discharge amount in the section T1 and the weight ratio of the cargo group 3C, 3D, that the carbon discharge amount of the cargo group 3C in the section is 60 [kg-CO₂/kWh]. Further, the control unit 23 calculates that the carbon emission of the cargo group 3D in the section T1 is 40 [kg-CO₂/kWh].

For example, in the section T2 in FIG. 4, the control unit 23 calculates that the weight ratio of the cargo group 3C, 3D, 3E is (the cargo group 3C: the cargo group 3D: the cargo group 3E=3:2:5) based on the parameter of the cargo group 3C, 3D, 3E. The control unit 23 calculates, based on T2 of the section 300 [kg-CO₂/kWh] of the carbon discharge amount and the weight ratio of the cargo group 3C, 3D, 3E, that the carbon discharge amount of the cargo group 3C in the section T2 is 90 [kg-CO₂/kWh]. Further, the control unit 23 calculates that the carbon emission of the cargo group 3D in the section T2 is 60 [kg-CO₂/kWh]. Further, the control unit 23 calculates that the carbon emission of the cargo group 3E in the section T2 is 150 [kg-CO₂/kWh].

For example, in the section T3 in FIG. 4, the control unit 23 calculates that the weight ratio of the cargo group 3C, 3E is (the cargo group 3C: the cargo group 3E=3:5) based on the parameter of the cargo group 3C, 3E. The control unit 23 calculates, based on T3 of the section 200 [kg-CO₂/kWh] of the carbon discharge amount and the weight ratio of the cargo group 3C, 3E, that the carbon discharge amount of the cargo group 3C in the section T3 is 75 [kg-CO₂/kWh]. Further, the control unit 23 calculates that the carbon emission of the cargo group 3E in the section T3 is 125 [kg-CO₂/kWh].

The control unit 23 calculates the carbon discharge amount for each of the plurality of cargo groups based on the calculation result of the carbon discharge amount for each of the plurality of cargo groups in the section.

For example, in the cargo group 3C, the control unit 23 adds 60 [kg-CO₂/kWh] of the carbon emission amount of the cargo group 3C in the section T1, 75 [kg-CO₂/kWh] of the cargo group 3C in the section T2, and 90 [kg-CO₂/kWh] of the cargo group 3C in the section T3. The control unit 23 calculates that the carbon emission of the cargo group 3C is 225 [kg-CO₂/kWh].

For example, in the cargo group 3D, the control unit 23 adds 40 [kg-CO₂/kWh] of the carbon discharge amount of the cargo group 3D in the section T1 and 60 [kg-CO₂/kWh] of the carbon discharge amount of the cargo group 3D in the section T2. The control unit 23 calculates that the carbon emission of the cargo group 3D is 100 [kg-CO₂/kWh].

For example, in the cargo group 3E, the control unit 23 adds 150 [kg-CO₂/kWh] of the carbon discharge amount of the cargo group 3E in the section T2 and 125 [kg-CO₂/kWh] of the carbon discharge amount of the cargo group 3E in the section T3. The control unit 23 calculates that the carbon emission of the cargo group 3E is 275 [kg-CO₂/kWh].

As described above, in the information processing device 20 according to the present embodiment, the control unit 23 calculates the carbon discharge amount for each of the plurality of cargo groups based on the data of the carbon discharge amount of the vehicle 10 and the plurality of parameters correlated with the respective weights of the plurality of cargo groups. By calculating the carbon discharge amount for each of the plurality of cargo groups, it is possible to grasp, for each of the cargo holders, how much the cargo of the cargo holder contributes to the carbon discharge amount even when the cargo of the different cargo holders is transported.

Further, in the present embodiment, the route from the departure point of the vehicle 10 to the destination may include a section in which a plurality of cargo groups of at least a part of the plurality of cargo groups transported by the vehicle 10 are transported. The control unit 23 may calculate the carbon discharge amount for each of the at least some of the plurality of cargo groups in the section based on the data of the carbon discharge amount of the vehicle 10 in the section and the plurality of parameters correlated with the respective weights of the at least some of the plurality of cargo groups. With such a configuration, as shown in FIG. 4, even when the relay point is included in the route from the departure point to the destination of the vehicle 10, the carbon emission amount for each cargo group can be calculated. A group of luggage is loaded on the vehicle 10 or a group of luggage is unloaded from the vehicle 10 at the relay site.

Although the present disclosure has been described above based on the drawings and the embodiment, it should be noted that those skilled in the art may make various modifications and alterations thereto based on the present disclosure. It should be noted, therefore, that these modifications and alterations are within the scope of the present disclosure. For example, the functions or the like included in each component or each step or the like can be rearranged so as not to logically contradict each other, and a plurality of components or steps or the like can be combined or divided into one.

For example, in Example 4 described above with respect to FIG. 4, the plurality of parameters correlated with the respective weights of the plurality of cargo group 3C, 3D, 3E are described as indicating the weights of the plurality of cargo group 3C, 3D, 3E. However, the plurality of parameters correlated with the respective weights of the plurality of cargo group 3C, 3D, 3E may be other parameters such as the respective volumes of the plurality of cargo group 3C, 3D, 3E.

For example, in the above-described embodiments, the plurality of parameters correlated with the weight of each of the plurality of cargo groups is described as indicating the weight, volume, or density of each of the plurality of cargo groups. However, the plurality of parameters may be correlated with the respective weights of the plurality of cargo groups, and are not limited thereto. As another example, the plurality of parameters may be a combination of volume and density of the plurality of cargo groups.

For example, in the above-described embodiment, the configuration and operation of the information processing device 20 may be distributed among a plurality of computers capable of communicating with each other. Furthermore, for example, an embodiment in which a part of or all of the components of the information processing device 20 are provided in the vehicle 10 is also possible. For example, the communication device 11 of the vehicle 10 may include some or all of the constituent elements of the information processing device 20.

For example, a general-purpose computer may function as the information processing device 20 according to the above-described embodiment. Specifically, a program describing processing contents for realizing each function of the information processing device 20 according to the above embodiment is stored in a memory of the general-purpose computer, and the program is read out and executed by the processor. Therefore, the present disclosure can also be realized as a program that can be executed by the processor or a non- transitory computer-readable medium that stores the program.

What is claimed is:

1. An information processing device comprising
a control unit that acquires data on a carbon emission amount of a vehicle and a plurality of parameters correlated with respective weights of a plurality of cargo groups transported by the vehicle, the cargo groups including at least one cargo, wherein
the control unit calculates a carbon emission amount for each of the cargo groups based on the data on the carbon emission amount of the vehicle and the parameters.

2. The information processing device according to claim 1, wherein:
the parameters indicate the respective weights of the cargo groups; and
the control unit is configured to
calculate weight ratios of the cargo groups using the parameters, and
calculate the carbon emission amount for each of the cargo groups based on the data on the carbon emission amount of the vehicle and the weight ratios of the cargo groups.

3. The information processing device according to claim 1, wherein:
the parameters indicate respective volumes of the cargo groups; and
the control unit is configured to
calculate volume ratios of the cargo groups using the parameters, and
calculate the carbon emission amount for each of the cargo groups based on the data on the carbon emission amount of the vehicle and the volume ratios of the cargo groups.

4. The information processing device according to claim 1, wherein:
a route from a departure location to a destination of the vehicle includes a section in which a plurality of cargo groups that is at least some of the cargo groups is transported; and
the control unit calculates a carbon emission amount for each of the at least some of the cargo groups in the section using data on the carbon emission amount of the vehicle in the section and a plurality of parameters correlated with respective weights of the at least some of the cargo groups.

5. The information processing device according to claim 4, wherein the control unit calculates a carbon emission amount for each of the cargo groups transported by the vehicle based on a result of calculating the carbon emission amount for each of the at least some of the cargo groups in the section.
